(19) United States
(12) Patent Application Publication
(10) Pub. No.: US 2026/0288317 A1
(43) Pub. Date: Sep. 24, 2026

(54) MANAGING ANIMATION SPEED OF A ZOOM ANIMATION

(71) Applicant: QUALCOMM Incorporated, San Diego, CA (US)

(72) Inventors: Zhiguo LI, Beijing (CN); Nan ZHANG, Beijing (CN); Yongjun XU, Beijing (CN)

(21) Appl. No.: 19/475,556

(22) PCT Filed: Jun. 1, 2023
(86) PCT No.: PCT/CN2023/097717

§ 371 Date: Oct. 15, 2025

(51) Int. Cl. G06F 3/04845; G06V 40/18

(52) U.S. Cl. CPC G06F 3/04845; G06V 40/18; G06F 2203/04806

(57) ABSTRACT

Various embodiments include systems and methods for managing an animation speed of a zoom animation presented on a display of a computing device. Various embodiments include determining a distance between a display of the computing device and eyes of a user, and adjusting a speed of a zoom animation presented on the display based on the determined distance between the display and the eyes of the user.

### BACKGROUND

Computing devices, such as smartphones, can display images in graphical user interfaces that enable a user to adjust the size of displayed objects in response to user inputs, such as a pinch in or pinch out gesture movement of fingertips on the display.

### SUMMARY

Various aspects include methods of managing an animation speed of a zoom animation presented on a display of a computing device. Some aspects include determining a distance between a display of the computing device and eyes of a user, and adjusting a speed of a zoom animation presented on the display based on the determined distance between the display and the eyes of the user.

In some aspects, adjusting the speed of the zoom animation presented on the display based on the determined distance between the display and the eyes of the user may include decreasing the speed of the zoom animation as the distance between the display and the eyes of the user decreases. In some aspects, determining the distance between the display and the eyes of the user may include determining dynamically the distance between the display and the eyes of the user based on one or more images of the user's face received from a camera of the computing device, and adjusting the speed of the zoom animation presented on the display based on the determined distance between the display and the eyes of the user may include adjusting the speed of the zoom animation dynamically based on the dynamically determined distance between the display and the eyes of the user.

In some aspects, determining the distance between the display and the eyes of the user may include applying one or more images of the user's face to a trained model configured to provide as an output the distance between the display and the eyes of the user. Some aspects may include determining a minimum zoom speed and a maximum zoom speed based on the determined distance between the display and the eyes of the user. In such aspects, adjusting the speed of the zoom animation presented on the display may include adjusting the speed of the zoom animation presented on the display within the minimum zoom speed and the maximum zoom speed. In some aspects, adjusting the speed of the zoom animation presented on the display based on the determined distance between the display and the eyes of the user of may include scaling an input received by the computing device to change the size of a one or more objects presented on the display based on the determined distance between the display and the eyes of the user.

Further aspects may include a computing device, such as a smartphone, having a processor configured with processor-executable instructions to perform various operations corresponding to the methods discussed above. Further aspects may include a non-transitory processor-readable storage medium having stored thereon processor-executable instructions configured to cause a processor to perform various operations corresponding to the method operations discussed above. Further aspects may include a computing device having various means for performing functions corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A illustrates an example system suitable for implementing various embodiments.

FIG. 1B illustrates a zoom animation resulting from the produced image frames.

FIG. 2 is a component block diagram illustrating a computing system that could be configured to implement some embodiments.

FIGS. 3A and 3B are process flow diagrams illustrating a method of managing the animation speed of a zoom animation according to various embodiments.

FIG. 4 is a component block diagram illustrating an example computing device suitable for use with various embodiments.

FIG. 5 is a component block diagram illustrating an example wireless communication device suitable for use with various embodiments.

FIG. 6 illustrates an example wearable computing device in the form of a smart watch suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and computing devices configured to implement the methods, for managing an animation speed of a zoom animation presented on a display of a computing device. In some embodiments, a processor or processing system of a computing device may adjust a speed of the zoom animation presented on a computing device's display based on a determined distance between the display and the eyes of a user of the computing device.

The term “computing device” may be used herein to refer to any one or all of quantum computing devices, Edge computing devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processor that can be configured to provide the functionality of various embodiments.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC also may include any number of general purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. SoCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard, in a single UE, or a single CPU device. The proximity of the SoCs facilitates high speed communications and the sharing of memory and resources.

Many applications on computing devices support the ability to zoom into or out from an image or text using an input to a touchscreen device or trackpad device. For example, some computing devices are configured to interpret a “gesture” such as using two fingers to control the size of an image or to adjust a font size (e.g., decreasing a distance between two fingers on a touchscreen (sometimes called a “pinch” gesture) or increasing the distance between such two fingers (sometimes called a “reverse pinch” or “pinch out” gesture). However, the rate at which the computing device changes the size of a displayed image or text in response to a such a gesture—that is, the speed of the zoom animation presented on the display—is the same under all circumstances. However, using the same zoom animation speed and all circumstances regardless of the distance between the computing device's display screen and the user's eyes, may impact the user experience. For example, the user may hold the computing device closer to the user's eyes in order to focus more closely on a detail of an image or text. The user may then attempt to “zoom in” using an appropriate gesture command. However, the computing device may present a zoom animation that is too rapid for the user's eyes to track given the short distance between the display and the user's eyes, which may frustrate the user.

Various embodiments include methods and computing devices configured to perform the methods of managing the animation speed of a zoom animation presented on a display of a computing device based on the distance between the display and the user's eyes. In various embodiments, the computing device may determine the distance between the display of the computing device and eyes of a user, identify or adjust a speed of a zoom animation presented on the display based on the determined distance, and present the zoom animation on the display using the identified or adjusted animation speed. In some embodiments, adjusting the speed of the zoom animation presented by the display device may include adjusting a rate at which the size of one or more objects (e.g., images, text, etc.) presented by the display device is changed. In some embodiments, adjusting the speed of the zoom animation presented by the display device may include adjusting a rate at which the size of one or more objects presented by the display device changes responsive to a user input received by the computing device.

In some embodiments, the computing device may dynamically adjust the speed of the zoom animation as the distance between the display on the eyes of the user changes during the animation. For example, as the user moves the device closer to the user's eyes, the computing device may determine the distance between the display on the eyes of the user multiple times. In some embodiments, the computing device may decrease the speed of the zoom animation as the distance between the display and the eyes of the user decreases, and/or increase the speed of the zoom animation as the distance between the display and the eyes of the user increases.

In some embodiments, the computing device may determine a minimum zoom speed and a maximum zoom speed based on the determined distance between the display and the eyes of the user, and adjust the speed of the zoom animation presented on the display device within the minimum zoom speed and the maximum zoom speed. For example, some imaging devices and/or cameras may provide slightly inaccurate information about the distance between the display and the eyes of the user due to, for example, device limitations or flaws, low lighting conditions, or other suitable circumstances. In this manner, the computing device may avoid adjusting the speed of the zoom animation to be too slow or too fast for the relative positioning of the display and the user's eyes.

In some embodiments, the computing device may scale an input received by the computing device to change the size of the one or more objects presented on the display based on the determined distance between the display and the eyes of the user. For example, the computing device may receive a rapid input, such as a rapid pinch in, or rapid pinch out gesture, in which the user's fingers move quickly across the display screen or other input device. In some embodiments, a velocity of the input received by the computing device may exceed a velocity threshold. Based on the determined distance between the display and the eyes of the user, the computing device may scale or otherwise adjust the velocity of the received input to reduce the speed of the zoom animation that would otherwise be rendered in response to the velocity of the user input. For example, if a user is holding the computing device close to the user's eyes, and inputs a rapid gesture or command to zoom in, the computing device may scale the velocity of the received input to reduce a speed of the zoom animation based on the determined distance between the display and the eyes of the user.

Any of a number of known methods of measuring the distance between the computing device, particularly the display, and a user's eyes may be used in various embodiments. Many computing devices include a camera and/or other imaging device(s) oriented in substantially the same direction as the display (e.g., a “selfie” camera). Some such cameras may be configured to function as an always-on camera (AON) that may capture images and video even when the device is in a standby or locked mode. Computing devices equipped with a camera may measure the apparent distance between the user's eyes in a captured image and use trigonometric calculations to determine the distance between the display and the user's eyes. In some embodiments, the computing device may apply one or more images of the user's face to a trained model configured to provide as an output the distance between the display and the eyes of the user. Some computing devices may include LIDAR sensors, such as useful for facial recognition, which may also be used to measure the distance between the display and the user's eyes. Some computing devices may be equipped with other distance measuring sensors, such as radar or ultrasound sonar sensors, that can measure the distance between the display and the user's eyes.

Various embodiments improve the experience of users performing a zoom operation on an image element on a computing device by dynamically adjusting an animation of the zoom based on the distance between the computing device display and the user's eyes. Various embodiments improve the operation of computing device displays and address limitations of conventional displays in current computing devices to improve run-time zoom and magnification functionalities, and thereby improve the user experience.

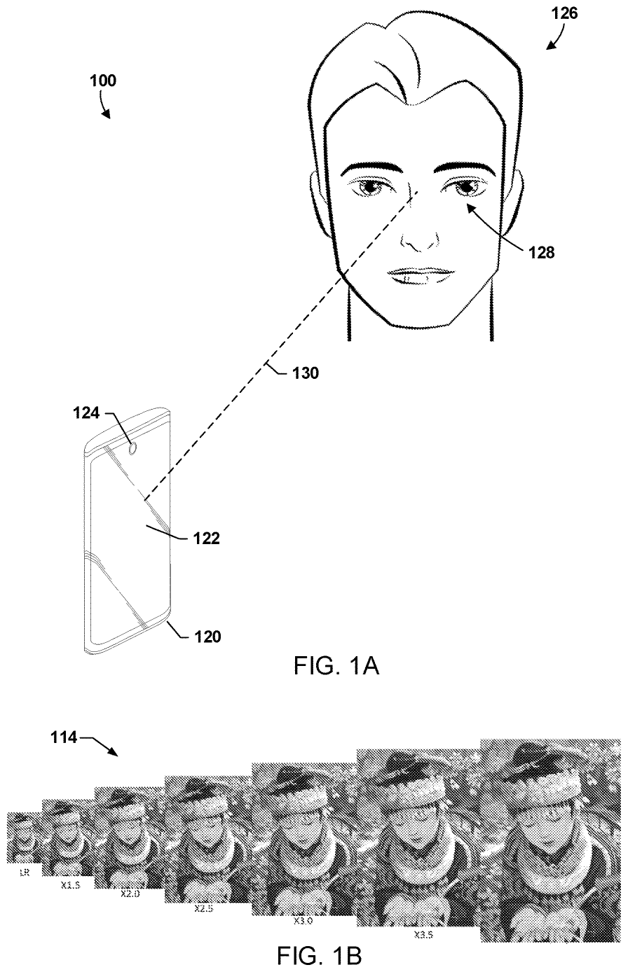

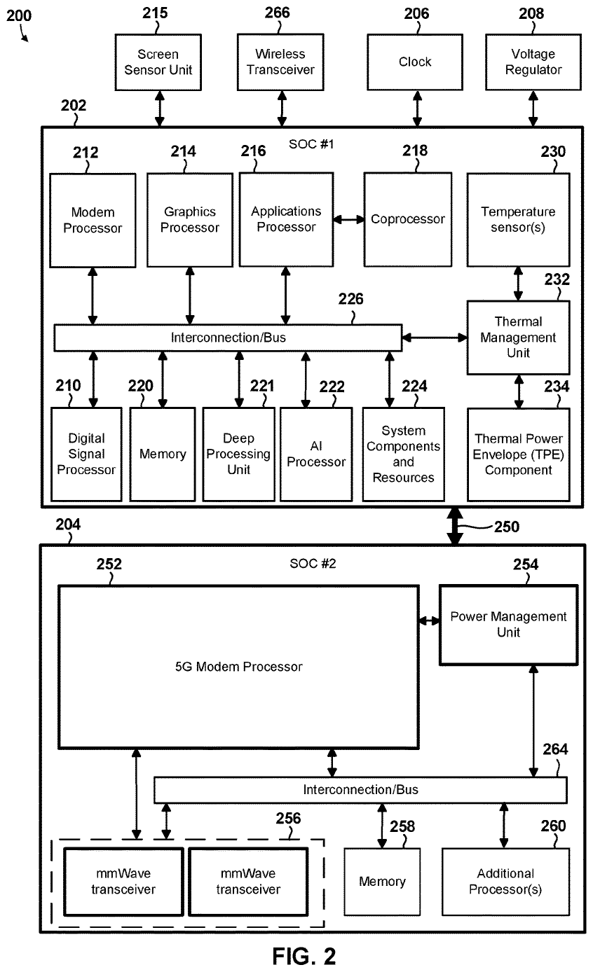

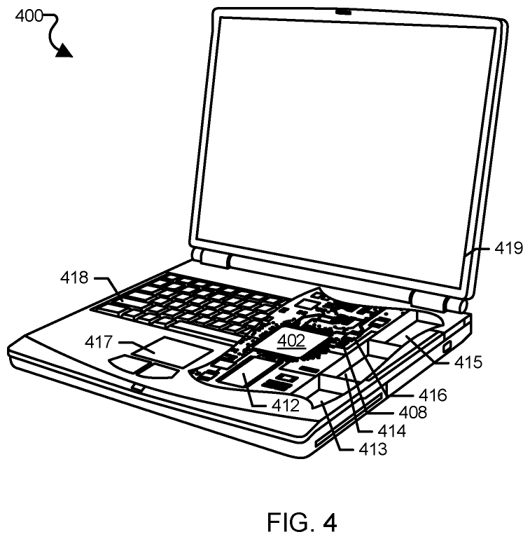

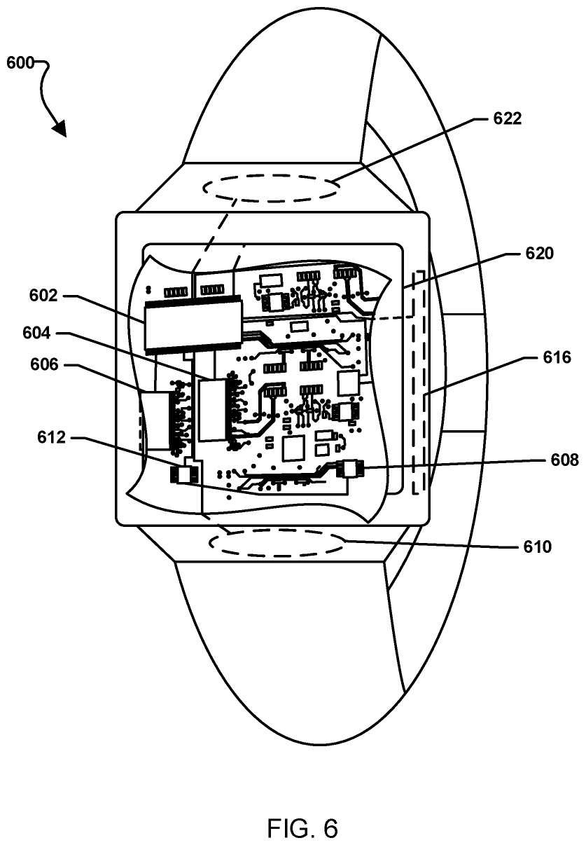

FIG. 1A illustrates an example system 100 suitable for implementing various embodiments. The system 100 may include a computing device 120, such as a smartphone, configured to implement a system for managing an animation speed of a zoom animation presented on a display. The computing device 120 may include a display 122, which may include an input device such as a touchscreen device, and one or more sensors 124 capable of obtaining data to measure distance to a user. Examples of such sensors 124 include cameras, LIDAR, radar, ultrasound sonar, and the like. The sensor(s) 124 may be directed to capture information (e.g., an image of a face of a user 126, lidar information, radar information, or other suitable information) usable by the computing device to determine the distance 130 between the display 122 and eyes 128 of the user 126. The display 122 may be configured to receive an input to zoom into or zoom out from one or more objects (e.g., image(s), text, etc.) presented on the display 122. For example, the display 122 may be a touchscreen device, and user inputs to zoom a displayed image may be in the from of two fingertips touching the display and then moving apart to enlarge the display (i.e., zoom in) or moving together to shrink the display (i.e., zoom out). The system 100 may be implemented in a wide variety of computing devices (including laptop computers as illustrated in FIG. 4 and smartwatches as illustrated in FIG. 6) and is not limited to a smart phone as illustrated in FIG. 1.

FIG. 1B illustrates an example of a zoom animation 114. The process of generating a zoom animation may begin with the user selecting an image layer or object in a display 122, such as a thumbnail image from an application, and inputting a zoom user input, such as touching a touch-sensitive display 122 with two fingers and moving the fingertips apart (e.g., a pinch out or reverse pinch gesture). In response to such a user input, the computing device may select or obtain a starting image frame and sequentially enlarge and display the frame on the display to render the zoom animation 114, continuing the enlarging and display sequence until the final size is achieved, such as in response to the user lifting the two fingers from the display 122.

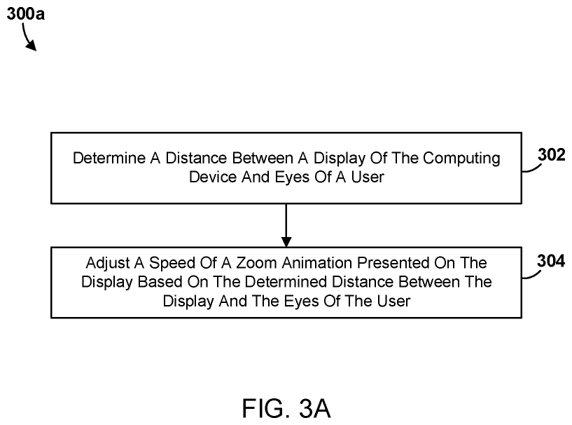

FIG. 2 illustrates an example computing system implemented as a system in a package (SIP) 200 suitable for implementing various embodiments. With reference to FIGS. 1A-2, various embodiments may be implemented in a variety of architectures that may be used in computing devices, including single processor, multiple processor, and multiprocessor computer systems, a system-on-chip (SOC), a SIP, and any combination thereof.

The SIP 200 may include a two SOCs 202, 204, a clock 206, and a voltage regulator 208. In some embodiments, the first SOC 202 may operate as central processing unit (CPU) of the computing device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mm Wave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, deep processing unit (DPU) 221, AI processor 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218, 221, 222, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 221, 222, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, Access ports, timers, and other similar components used to support the processors and software clients running on a UE device. The system components and resources 224 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224 and a thermal management unit 232 via an interconnection/bus module 226. Similarly, the processor 252 may be interconnected to the power management unit 254, the mm Wave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206, a voltage regulator 208, screen sensor unit 215 and a wireless transceiver 266 (e.g., cellular wireless transceiver, Bluetooth transceiver, etc.). Resources external to the SOC (e.g., clock 206, voltage regulator 208, screen sensor unit 215, wireless transceiver 266) may be shared by two or more of the internal SOC processors/cores.

In some embodiments, any or all of the processors 210, 212, 214, 216, 218, 221, 222, 252, 260 may implement a CNN-based AI image processing system, a Bilinear-Bicubic image processing pipeline and/or a convolutional neural network super resolution (CNN SR) image processing pipeline. For example, in some embodiments, a graphics processor unit (GPU) 214 and/or DPU 221 may implement a Bilinear-Bicubic pipeline and/or AI processor 222, GPU 214, and/or DSP 210 may implement a CNN SR pipeline.

In some embodiments, any or all of the processors 210, 212, 214, 216, 218, 221, 222, 252, 260 may be configured to work in conjunction with the screen sensor unit 215 to perform a zoom operation on a display of a computing device in accordance with the embodiments. For example, the screen sensor unit 215 may monitor end user's touch gestures to conditionally trigger a layer dynamic seamless zoom and corresponding sequential up-scaling animation frames in continuous varying up-scale step factors (1.0--1.01-1.02--1.03---XXXXX--1.99, 2.00, 2.01-XXXXX-----3.0). The screen sensor unit 215 may detect a zoom user input on an image layer within the display presented on an electronic display of the computing device, and send the information to the GPU 214 and AI processor 222. The GPU 214 may receive the zoom user input, and use an interpolation scaling technique in a first image processing pipeline to adjust a displayed size of the image layer. In parallel, the AI processor 222 may use a super resolution technique in a second image processing pipeline to adjust the displayed size of the image layer. The AI processor 222, GPU 214 and/or another processor (e.g., applications processor 216) may upscale an output of the interpolation scaling technique on the first image processing pipeline with an output from the super resolution technique on the second image processing pipeline to generate an upscaled frame of the image layer, and cause an electronic display of a computing device to display the upscaled frame of the image layer.

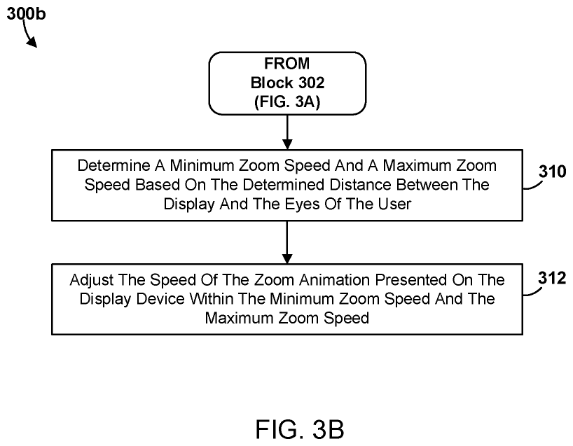

FIG. 3A illustrates a method 300a of managing an animation speed of a zoom animation presented on a display of a computing device according to various embodiments. With reference to FIGS. 1A-3A, means for performing operations of the method 300a may include one or more processors (e.g., processors 210, 212, 214, 216, 218, 221, 222, 252, 260) in a computing device (e.g., 120, 200).

In block 302, the processor may determine a distance between a display of the computing device and eyes of a user. In some embodiments, the processor may use information received from a camera, a lidar device, radar device, or another suitable device of the computing device. In some embodiments, determining the distance between the display and the eyes of the user may include applying one or more images of the user's face to a trained model configured to provide as an output the distance between the display and the eyes of the user. In some embodiments, determining the distance between the display and the eyes of the user may include determining dynamically the distance between the display device and the eyes of the user based on one or more images of a user's face received from a camera of the computing device.

In block 304, the processor may adjust a speed of a zoom animation presented on the display based on the determined distance between the display and the eyes of the user. In some embodiments, adjusting the speed of the zoom animation presented by the display device may include adjusting a rate at which a size is changed of one or more objects (e.g., images, text, etc.) presented by the display device. In some embodiments, adjusting the speed of the zoom animation presented by the display device may include adjusting a rate at which a size is changed of one or more objects presented by the display device responsive to an input received by the computing device to change the size of the one or more objects presented by the display device. In some embodiments, adjusting a speed of the zoom animation presented on the display based on the determined distance between the display and the eyes of the user may include decreasing the speed of the zoom animation as the distance between the display and the eyes of the user decreases.

In some embodiments, adjusting the speed of the zoom animation presented on the display based on the determined distance between the display and the eyes of the user may include adjusting the speed of the zoom animation dynamically based on the dynamically determined distance between the display and the eyes of the user. In some embodiments, adjusting the speed of the zoom animation presented on the display based on the determined distance between the display and the eyes of the user of may include scaling an input received by the computing device to change the size of the one or more objects presented on the display based on the determined distance between the display and the eyes of the user.

In various embodiments, the processor may present the zoom animation on the display of the computing device using the adjusted speed.

FIG. 3B illustrates operations 300b that may be performed as part of the method 300a of managing an animation speed of a zoom animation presented on a display of a computing device according to various embodiments. With reference to FIGS. 1A-3B, means for performing the operations 300a may include one or more processors (e.g., processors 210, 212, 214, 216, 218, 221, 222, 252, 260) in a computing device (e.g., 120, 200).

Following the determination of the distance between a display of the computing device and eyes of a user in block 302 of the method 300a as described, the processor may determine a minimum zoom speed and a maximum zoom speed based on the determined distance between the display and the eyes of the user in block 310. In block 312, the processor may adjust the speed of the zoom animation presented on the display device within the minimum zoom speed and the maximum zoom speed.

FIG. 6 is a component block diagram of a computing device suitable for use with various embodiments. With reference to FIGS. 1A-6, in some embodiments, the computing device may be implemented in the form of a laptop computer 400. In various embodiments, the laptop computer 400 may include a touchpad (or trackpad) touch surface 417 that serves as the computer's pointing device, and thus may receive pinch in, pinch out, drag, scroll, flick gestures, etc. similar to those that may be implemented on computing devices equipped with a touch screen display. The laptop computer 400 may include a processor 402 coupled to volatile memory 412 and a large capacity nonvolatile memory, such as a disk drive 413 of Flash memory. Additionally, the laptop computer 400 may include one or more antenna 408 for sending and receiving electromagnetic radiation that may be connected to a wireless data link and/or cellular telephone transceiver 416 coupled to the processor 402. The laptop computer 400 may also include a transceiver 414 implementing short range wireless communication using a variety of short-range communication protocols, such as any of the Institute of Electrical and Electronics Engineers (IEEE) 802.11 and 802.15 protocols. The laptop computer 400 also may include a compact disc (CD) drive 415 coupled to the processor 402. The laptop computer 400 may include a touchpad 417, a keyboard 418, and a display 419 all coupled to the processor 402. Other configurations of the laptop computer 400 may include a computer mouse or trackball coupled to the processor (e.g., via a Universal Serial Bus (USB) input) as are well known, which may also be used in conjunction with various embodiments.

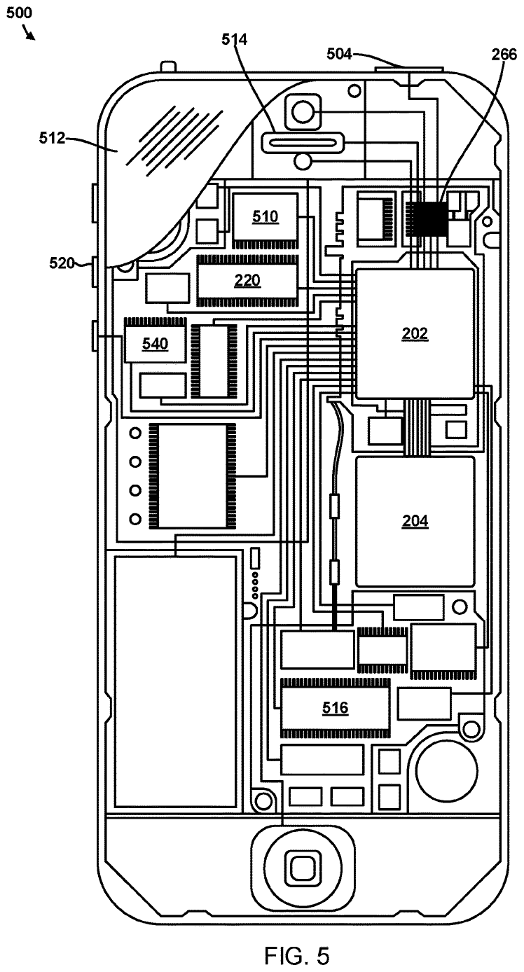

FIG. 5 is a component block diagram of a computing device suitable for use with various embodiments. With reference to FIGS. 1A-5, in some embodiments, the computing device may be implemented in the form of a smartphone 500. The smartphone 500 may include a first circuitry 202 coupled to a second circuitry 204. The first and second SoCs 202, 204 may be coupled to internal memory 516, a display 512, and to a speaker 514. The display 512 may include or incorporate a touch sensitive input device configured to receive an input such as pinch in, pinch out, drag, scroll, flick gestures, etc. The first and second circuitries 202, 204 may also be coupled to at least one subscriber identity module (SIM) 540 and/or a SIM interface that may store information supporting a first 5GNR subscription and a second 5GNR subscription, which support service on a 5G non-standalone (NSA) network.

The smartphone 500 may include an antenna 504 for sending and receiving electromagnetic radiation that may be connected to a wireless transceiver 266 coupled to one or more processors in the first and/or second circuitries 202, 204. The smartphone 500 also may include menu selection buttons or rocker switches 520 for receiving user inputs. The smartphone 500 also may include a sound encoding/decoding (CODEC) circuit 510, which digitizes sound received from a microphone into data packets suitable for wireless transmission and decodes received sound data packets to generate analog signals that are provided to the speaker to generate sound. Also, one or more of the processors in the first and second circuitries 202, 204, wireless transceiver 266 and CODEC 510 may include a digital signal processor (DSP) circuit (not shown separately).

FIG. 8 is a component block diagram of a computing device suitable for use with various embodiments. With reference to FIGS. 1A-8, in some embodiments, the computing device may be implemented in the form of a smart watch 600.

The smart watch 600 may include an SoC 602 including two or more processors (e.g., application processor, low power processor) coupled to internal memories 604 and 606. Internal memories 604, 606 may be volatile or non-volatile memories, and may also be secure and/or encrypted memories, or unsecure and/or unencrypted memories, or any combination thereof. The SoC 602 may also be coupled to a touchscreen display 620, such as a resistive-sensing touchscreen, capacitive-sensing touchscreen infrared sensing touchscreen, or the like. Additionally, the smart watch 600 may have one or more antenna 608 for sending and receiving electromagnetic radiation that may be connected to one or more wireless data links 612, such as one or more Bluetooth® transceivers that may be coupled to the SoC 602.

The smart watch 600 may also include physical and/or virtual buttons 622 and 610 for receiving user inputs as well as a slide sensor 616 for receiving user inputs. The touchscreen display 620 may be coupled to a touchscreen interface module that is configured receive signals from the touchscreen display 620 indicative of locations on the screen where a user's fingertip or a stylus is touching the surface and output to the SoC 602 information regarding the coordinates of touch events. The physical and/or virtual buttons 622 and touchscreen display 620 may be configured to receive an input such as pinch in, pinch out, drag, scroll, flick gestures, etc. Further, the SoC 602 may be configured with processor-executable instructions to correlate images presented on the touchscreen display 620 with the location of touch events received from the touchscreen interface module in order to detect when a user has interacted with a graphical interface icon, such as a virtual button.

The SoC 602 may be any programmable microprocessor, microcomputer or multiple processor chip or chips that can be configured by software instructions (applications) to perform a variety of functions, including the functions of various embodiments. In some devices, multiple processors may be provided, such as one processor dedicated to wireless communication functions and one processor dedicated to running other applications. Typically, software applications may be stored in an internal memory before they are accessed and loaded into the SoC 602. The SoC 602 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 602 including internal memory or removable memory plugged into the wearable device and memory within the SoC 602 itself.

The processors of the laptop computer 600, the smart phone 500, and the smart watch 600 may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1 A method of managing an animation speed of a zoom animation presented on a display of a computing device, including determining a distance between the display of the computing device and eyes of a user, and adjusting a speed of a zoom animation presented on the display based on the determined distance between the display and the eyes of the user.

Example 2. The method of example 1, in which adjusting the speed of the zoom animation presented on the display based on the determined distance between the display and the eyes of the user includes decreasing the speed of the zoom animation as the distance between the display and the eyes of the user decreases.

Example 3. The method of either of examples 1 or 2, in which determining the distance between the display and the eyes of the user includes determining dynamically the distance between the display and the eyes of the user based on one or more images of the user's face received from a camera of the computing device, and adjusting the speed of the zoom animation presented on the display based on the determined distance between the display and the eyes of the user includes adjusting the speed of the zoom animation dynamically based on the dynamically determined distance between the display and the eyes of the user.

Example 4. The method of any of examples 1-3, in which determining the distance between the display and the eyes of the user includes applying one or more images of the user's face to a trained model configured to provide as an output the distance between the display and the eyes of the user.

Example 5. The method of any of examples 1-4, further including determining a minimum zoom speed and a maximum zoom speed based on the determined distance between the display and the eyes of the user, in which adjusting the speed of the zoom animation presented on the display includes adjusting the speed of the zoom animation presented on the display within the minimum zoom speed and the maximum zoom speed.

Example 6. The method of any of examples 1-5, in which adjusting the speed of the zoom animation presented on the display based on the determined distance between the display and the eyes of the user of includes scaling an input received by the computing device to change the size of a one or more objects presented on the display based on the determined distance between the display and the eyes of the user.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of managing an animation speed of a zoom animation presented on a display of a computing device, comprising:
determining a distance between the display of the computing device and eyes of a user; and
adjusting a speed of a zoom animation presented on the display based on the determined distance between the display and the eyes of the user.

2. The method of claim 1, wherein adjusting the speed of the zoom animation presented on the display based on the determined distance between the display and the eyes of the user comprises decreasing the speed of the zoom animation as the distance between the display and the eyes of the user decreases.

3. The method of claim 1, wherein:
determining the distance between the display and the eyes of the user comprises determining dynamically the distance between the display and the eyes of the user based on one or more images of the user's face received from a camera of the computing device, and
adjusting the speed of the zoom animation presented on the display based on the determined distance between the display and the eyes of the user comprises adjusting the speed of the zoom animation dynamically based on the dynamically determined distance between the display and the eyes of the user.

4. The method of claim 1, wherein determining the distance between the display and the eyes of the user comprises applying one or more images of the user's face to a trained model configured to provide as an output the distance between the display and the eyes of the user.

5. The method of claim 1, further comprising determining a minimum zoom speed and a maximum zoom speed based on the determined distance between the display and the eyes of the user,
wherein adjusting the speed of the zoom animation presented on the display comprises adjusting the speed of the zoom animation presented on the display within the minimum zoom speed and the maximum zoom speed.

6. The method of claim 1, wherein adjusting the speed of the zoom animation presented on the display based on the determined distance between the display and the eyes of the user of comprises scaling an input received by the computing device to change the size of a one or more objects presented on the display based on the determined distance between the display and the eyes of the user.

7. A computing device, comprising:
a display; and
a processor coupled to the display and configured to:
determine a distance between the display and eyes of a user; and
adjust a speed of a zoom animation presented on the display based on the determined distance between the display and the eyes of the user.

8. The computing device of claim 7, wherein the processor is further configured to decrease the speed of the zoom animation as the distance between the display and the eyes of the user decreases.

9. The computing device of claim 7, wherein the processor is further configured to:
determine dynamically the distance between the display and the eyes of the user based on one or more images of the user's face received from a camera of the computing device, and
adjust the speed of the zoom animation dynamically based on the dynamically determined distance between the display and the eyes of the user.

10. The computing device of claim 7, wherein the processor is further configured to apply one or more images of the user's face to a trained model configured to provide as an output the distance between the display and the eyes of the user.

11. The computing device of claim 7, wherein the processor is further configured to:
determine a minimum zoom speed and a maximum zoom speed based on the determined distance between the display and the eyes of the user, and
adjust the speed of the zoom animation presented on the display within the minimum zoom speed and the maximum zoom speed.

12. The computing device of claim 7, wherein the processor is further configured to scale an input received by the computing device to change the size of a one or more objects presented on the display based on the determined distance between the display and the eyes of the user.

13. A computing device, comprising:
a display;
means for determining a distance between the display of the computing device and eyes of a user; and
means for adjusting a speed of a zoom animation presented on the display based on the determined distance between the display and the eyes of the user.

14. The computing device of claim 13, wherein means for adjusting the speed of the zoom animation presented on the display based on the determined distance between the display and the eyes of the user comprises means for decreasing the speed of the zoom animation as the distance between the display and the eyes of the user decreases.

15. The computing device of claim 13, wherein:
means for determining the distance between the display and the eyes of the user comprises means for determining dynamically the distance between the display and the eyes of the user based on one or more images of the user's face received from a camera of the computing device, and
means for adjusting the speed of the zoom animation presented on the display based on the determined distance between the display and the eyes of the user comprises means for adjusting the speed of the zoom animation dynamically based on the dynamically determined distance between the display and the eyes of the user.

16. The computing device of claim 13, wherein means for determining the distance between the display and the eyes of the user comprises means for applying one or more images of the user's face to a trained model configured to provide as an output the distance between the display and the eyes of the user.

17. The computing device of claim 13, further comprising means for determining a minimum zoom speed and a maximum zoom speed based on the determined distance between the display and the eyes of the user,
wherein means for adjusting the speed of the zoom animation presented on the display comprises means for adjusting the speed of the zoom animation presented on the display within the minimum zoom speed and the maximum zoom speed.

18. The computing device of claim 13, wherein means for adjusting the speed of the zoom animation presented on the display based on the determined distance between the display and the eyes of the user of comprises means for scaling an input received by the computing device to change the size of a one or more objects presented on the display based on the determined distance between the display and the eyes of the user.

19. A non-transitory processor-readable medium having stored thereon processor-executable instructions configured to cause a processing device in a computing device to perform operations comprising:
determining a distance between a display of the computing device and eyes of a user; and
adjusting a speed of a zoom animation presented on the display based on the determined distance between the display and the eyes of the user.

20-24. (canceled)
